(19) United States
(12) Patent Application Publication
(10) Pub. No.: US 2021/0150751 A1
(43) Pub. Date: May 20, 2021

(54) OCCLUSION-AWARE INDOOR SCENE ANALYSIS

(71) Applicant: NEC Laboratories America, Inc., Princeton, NJ (US)

(72) Inventors: Buyu Liu, Cupertino, CA (US); Samuel Schulter, New York, NY (US); Manmohan Chandraker, Santa Clara, CA (US)

(21) Appl. No.: 17/095,967

(22) Filed: Nov. 12, 2020

Related U.S. Application Data
(60) Provisional application No. 62/935,312, filed on Nov. 14, 2019.

(51) Int. Cl. G06T 7/70; G06T 3/00; G06K 9/62; G06K 9/72; G06T 5/50; G06T 7/194; G06N 20/00

(52) U.S. Cl. CPC G06T 7/70; G06T 3/0093; G06K 9/6256; G06K 9/6201; G06T 2207/20081; G06T 5/50; G06T 7/194; G06N 20/00; G06K 9/726

(57) ABSTRACT

Methods and systems for occlusion detection include detecting a set of foreground object masks in an image, including a mask of a visible portion of a foreground object and a mask of the foreground object that includes at least one occluded portion, using a machine learning model. A set of background object masks is detected in the image, including a mask of a visible portion of a background object and a mask of the background object that includes at least one occluded portion, using the machine learning model. The set of foreground object masks and the set of background object masks are merged using semantic merging. A computer vision task is performed that accounts for the at least one occluded portion of at least one object of the merged set.

### RELATED APPLICATION INFORMATION

This application claims priority to U.S. Application Ser. No. 62/935,312, filed on Nov. 14, 2020, incorporated herein by reference entirety.

### BACKGROUND

### Technical Field

The present invention relates to image processing, and more particularly, to using plane representations to identify occlusion within images.

### Description of the Related Art

While human vision is adept at identifying occlusions in a visual field, particularly identifying when one object is in front of another object. However, computerized image analysis has trouble with this task, particularly in indoor scenes, where the composition of objects and scenes may be very complex.

### SUMMARY

A method for occlusion detection includes detecting a set of foreground object masks in an image, including a mask of a visible portion of a foreground object and a mask of the foreground object that includes at least one occluded portion, using a machine learning model. A set of background object masks is detected in the image, including a mask of a visible portion of a background object and a mask of the background object that includes at least one occluded portion, using the machine learning model. The set of foreground object masks and the set of background object masks are merged using semantic merging. A computer vision task is performed that accounts for the at least one occluded portion of at least one object of the merged set.

A system for occlusion detection includes a hardware processor and a memory that stores computer program code. When executed by the hardware processor, the program code implements an occlusion inference model and a computer vision task. The occlusion inference model detects a set of foreground object masks in an image, including a mask of a visible portion of a foreground object and a mask of the foreground object that includes at least one occluded portion, detects a set of background object masks in the image, including a mask of a visible portion of a background object and a mask of the background object that includes at least one occluded portion, that merges the set of foreground object masks and the set of background object masks using semantic merging. A computer vision task takes into account the at least one occluded portion of at least one object of the merged set.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an image that includes a view of an interior scene, with objects that are partially occluded, in accordance with an embodiment of the present invention;

FIG. 2 is a block/flow diagram of a method of training a machine learning model to detect and infer the extend of occluded objects, in accordance with an embodiment of the present invention;

FIG. 3 is a block diagram of a machine learning model that has separate branches for foreground and background objects and that identifies masks for the visible portion of objects and for the full objects in a scene, in accordance with an embodiment of the present invention;

FIG. 4 is a block/flow diagram of a method for performing a computer vision task using information about occluded objects in an image, in accordance with an embodiment of the present invention;

FIG. 5 is a diagram of a high-level artificial neural network (ANN) machine learning model, in accordance with an embodiment of the present invention;

FIG. 6 is a diagram of a particular architecture fir ANN machine learning models, in accordance with an embodiment of the present invention; and

FIG. 7 is a block diagram of a computer vision system that performs occlusion inference, in accordance with an embodiment of the present invention.

### DETAILED DESCRIPTION OF PREFERRED EMBODIMENTS

Scenes may be represented as a set of planes, inferred from a single input image. Using the distinction in size and shape of planes on foreground objects, like chairs or tables, and background objects, like walls, these groups of objects may be predicted separately to lower output space variations. Furthermore, if multi-view inputs are available, then planes may be warped from one view to another to obtain a training signal.

A machine learning model, for example using a neural network model that infers a full scene representation, with reasoning about hidden areas, may be trained using data that includes a ground truth about the geometry and semantics of occluded areas. To obtain such training data, existing image datasets may be processed to provide approximate, but reliable, ground truth information for occlusion reasoning.

Occlusion detection is useful in a variety of applications, such as robot navigation and augmented reality. By improving the detection and analysis of occlusion within images, the present principles provide distinct advances to any application that navigates through a real physical space using imagery. Although analysis of images of indoor settings is particularly contemplated, using images generated by cameras in visible wavelengths, it should be understood that the present principles may be extended to any context, using any appropriate type of input data.

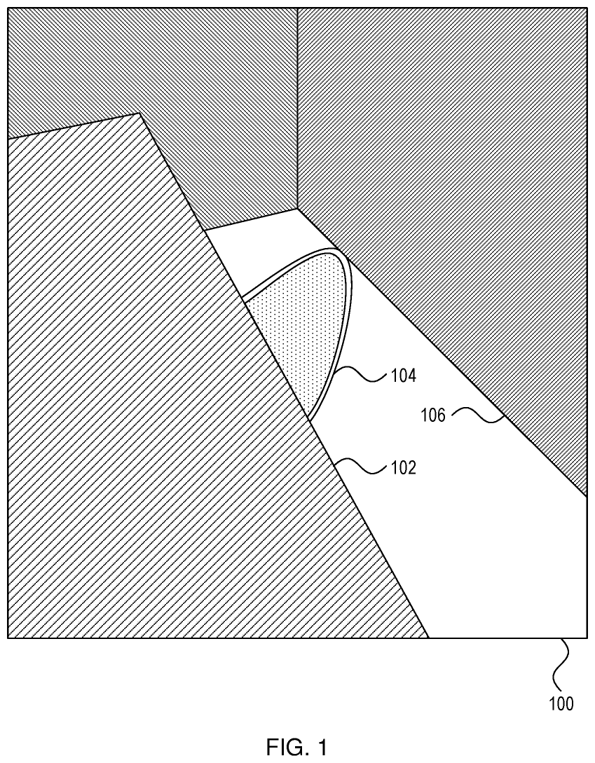

Referring now in detail to the figures in which like numerals represent the same or similar elements and initially to FIG. 1, an exemplary image 100 is shown. The image 100 includes a view of an interior scene, with a table 102 partially occluding the view of a chair 104. Also shown are objects like walls 106 and the floor, which may be partially occluded by foreground objects. The walls 106 may be considered background surfaces, while the table 102 and the chair 104 may be considered as being part of the foreground.

Planes can be used to compactly describe the scene in a semi-parametric way, with each plane being defined by a normal vector, and offset, and a mask that outlines the boundaries of the plane. A machine learning model may be used to predict both the visible and occluded extent of each plane, separating the prediction of planes based on semantics. Toward this end, a metric may be used that is designed for occluded areas, for example an average precision hidden metric. The present principles provide superior detection of occlusion areas, without compromising reasoning on the visible parts of planes.

Machine learning may be used to identify occluded objects. For example, a dataset may be used to generate a machine learning ground truth, for example using input data that includes mesh information relating to a room's layout. The mesh may be converted to a set of multiple planes, with each plane being represented by a normal vector, an offset, and two masks—one mask for the visible part of a plane from a given perspective, taking occlusion into account, and the other mask for the full extent of the plane, regardless of occlusion. The former is referred to herein as the visible mask, while the latter is referred to herein as the complete mask. The normal vector indicates the direction of the plane, while the offset represents the closest distance from the camera's position to the plane. The masks thus represent the size and shape of the plane.

A depth map may also be used for a full representation of a scene, for areas that are not covered by any plane. For every view of the scene, camera parameters can be used to compute the masks and other parameters of the plane representations.

There may be holes in the complete masks for the occluded areas, for example due to camera views and noise in the meshes, which are artifacts of the data generation process. However, complete planes, such as walls, floors, and tabletops, are often of convex shapes, while holes generally occur inside the full planes. Thus, the complete masks can be filled to be the convex closure. The filled areas can be flagged to be ignored, such that they have no influence on training, to account for the uncertainty of whether a given hole really existed.

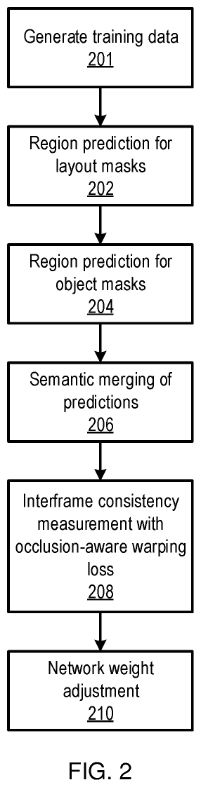

Referring now to FIG. 2, a method of training an occlusion detector is shown. Block 201 generates the training data, for example from a corpus of multi-view scene information. Such information may include a mesh that represents recorded three-dimensional contours of a particular scene. Block 201 may convert each such mesh to plane information for a view, for example by identifying a mask that represents the objects that are visible from a camera viewpoint, and also identifying masks that represent the true, complete shape of the objects from the occluded mesh. Multiple different views may be generated from a single scene to add to the training data.

Blocks 202 and 204 generate region predictions for layout masks and for object masks, respectively, for a given input image. This input image may be the view of a training scene from the camera viewpoint. It should be understood that blocks 202 and 204 may be performed in any order, and may also be performed in parallel. Each block takes a same input image.

Planes may be detected by identifying the bounding boxes that enclose the planes. The normal and binary mask can be determined for each plane, indicating the location of the region and its orientation. Depth may also be determined, using a global feature map to predict per-pixel depth values in the image. Given the per-pixel depth and the visible planes, offsets may be determined for each plane.

With both visible and complete masks available, the variation in shape, size, and distribution of planes that belong to different categories become more varied than when only visible masks are available. Such object categories may include the categories of “floor” and “wall,” where large differences can be observed compared to foreground categories, but may furthermore include different categories for the visible and complete masks of a given plane. As such, the foreground and the background may be handled separately. The classes may thus be defined into separate groups, with category-specific networks being used to handle each, with object region prediction 204 being used for foreground categories, and with layout region prediction 202 being used for background categories.

The object region detection 204 may be trained with an object plane ground truth, while the layout region detection 202 may be trained with a layout plane ground truth. As a result, different priors are learned for each category, without adding too many parameters. Given a single image, the layout region detection may predict masks for background classes, such as walls and floors, while the object region detection may focus on foreground classes, while ignoring background objects.

Blocks 202 and 204 each output a respective set of predicted planes from the input image. Block 206 performs a semantic merging that obtains the final representation for the entire image. In simple cases, the union of the two sets may be used, with the full predictions representing the final results. Non-maxima suppression may be used over the full predictions, which has the advantage of avoiding duplicated results, but which may over-suppress planes.

Block 206 may thus use semantic merging. Non-maxima suppression may first be applied to the outputs of each of blocks 202 and 204. Then the suppressed results may be fused using semantic segmentation results. The overlap between visible masks from the object and layout branches may be checked, and, for those pairs with an overlapping score that is greater than a pre-defined threshold θ, semantic segmentation may be used to determine which plane(s) to keep.

For paired visible masks, a confidence score may be determined based on their overlapping score with respect to semantic segregation, and the mask with the higher confidence score may be kept in the final predictions. The overlapping score of the layout class can be determined by counting the percentage of pixels that are inside the layout visible mask and that belong to a layout class in the segmentation map, and vice versa. In practice, the threshold may be set to about 0=0.3.

During training, block 208 may use a training objective function that handles plane representations that leverage the availability of multiple views of the same scene. The objective function encourages consistency between planes across different views, taking advantage of the fact that plans which are occluded in one view may be visible in another. The objective function can therefore enforce consistency, even in hidden regions.

Given a camera transformation between two views, each predicted plane Pᵢ may be warped. The plane normal and offsets are projected by the camera rotation and translation. The mask of the predicted plane Pᵢ may then be projected to the other view using a bilinear interpolation. The warped plane may be denoted as P_{w}_{ᵢ}. Each warped prediction P_{w}_{ᵢ} is matched with ground truth planes P_{g}_{ⱼ}, which can be formalized as:

$${max}_{i , j} IoU ( {P}_{{g}_{i}} , {P}_{{w}_{j}} )$$

subject to:

Dₙ(P_{g}_{ᵢ},P_{w}_{ⱼ})≤η_{depths}\hat{ }IoU(P_{g}_{ᵢ},P_{w}_{ⱼ})≥ηᵢₒᵤ

with:

$${D}_{n} ( {P}_{{g}_{i}} , {P}_{{w}_{j}} ) = {‖ {N}_{{P}_{{g}_{i}}} \cdot {o}_{{g}_{i}} - {N}_{{P}_{{w}_{j}}} \cdot {o}_{{w}_{j}} ‖}^{2}$$

where IoU(·) calculates the intersection-over-union overlap between two planes, Nₚ and o indicate the normal and offset of a plane, and the two thresholds η_{depth} and ηᵢₒᵤ are hyper parameters that are set by the user, for example to 0.5 and 0.3, respectively. The objective function's loss value can then be calculated as the cross-entropy between the warped mask prediction and the matched neighbor ground truth mask, providing an additional training signal.

During training, block 208 uses an average precision hidden metric to determine the performance of the plane predictions. Fully visible planes {P_{g}^{FV}} and their corresponding estimations {P_{g}^{FV}} are removed. The j^{th} plane P_{g}_{ⱼ} belongs to {P_{g}^{FV}} as long as its hidden mask Area (G_{H}_{ⱼ})<κₐᵣₑₐ, where G_{H}_{ⱼ} is the visible mask of P_{g}_{ⱼ} and κₐᵣₑₐ is a threshold area. The i^{th} plane P_{g}_{ᵢ} belongs to {Pₑ^{FV}} as long as the output j of

$${argmax}_{j}$$

(IoU(Mᵢ,Gⱼ)) satisfies P_{g}_{ⱼ}∈{P_{g}^{FV}}, where Mᵢ is the complete mask of the i^{th} plane estimation Pₑ_{ᵢ}, and Gⱼ is the complete mask of the j^{th} ground truth P_{g}_{ⱼ}. A predicted plane that satisfies the following conditions may be determined to be a true positive:

IoU(Mᵢ∩G̅ᵥ_{ⱼ},G_{H}_{ⱼ})≥κᵢₒᵤ

D(Pₑ_{ᵢ},P_{g}_{ⱼ})≤κ_{depth}

P_{g}_{ⱼ}∉{P_{g}^{FV}},Pₑ_{ᵢ}∉{Pₑ^{FV}}

where G_{V}_{ⱼ} is the visible part of the complete mask Gⱼ. The function D(·) calculates a depth difference, and the thresholds κₐᵣₑₐ, κᵢₒᵤ, and κ_{depth} may be set to, e.g., 100 pixels, 0.5, and [0.4 m, 0.6 m, 0.9 m], respectively. By excluding the visible region from the ground truth, the metric focuses only on predictions in hidden regions.

Thus, block 208 can measure the difference between the merged predictions of block 206 and the expected ground truth from the training data. Block 210 may use this difference as an error or loss value, which can then be used to adjust weights of the two region prediction processes, thereby improving the inference of occluded information.

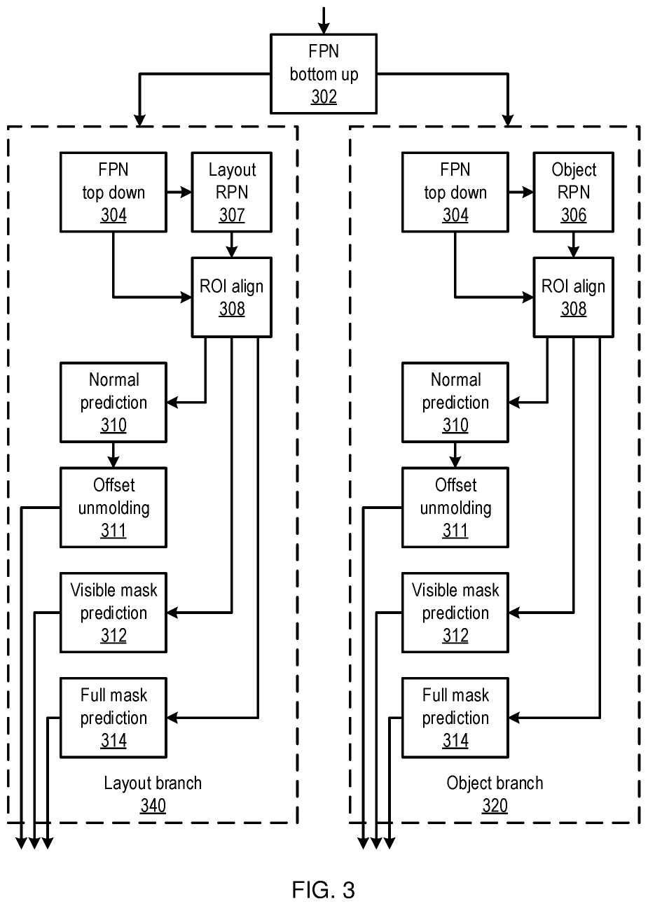

Referring now to FIG. 3, additional detail on blocks 202 and 204 is shown, detailing an object branch 320 and a layout branch 340 of a prediction network. A feature pyramid network (FPN) 302 receives an input image and generates features of the input image in a “bottom up” fashion, identifying features at multiple different scales. These features as input to respective top-down FPNs 304 in each branch, which generate further features. These features are used by a layout region prediction network 307 in the layout branch 340 and by an object region prediction network 306 in the object branch 302 to identify bounding boxes for the background objects and for the foreground objects, respectively. Block 308 aligns predicted bounding boxes with ground truth bounding boxes.

Using these bounding boxes, visible mask prediction 312 and full mask prediction 314 determine masks for the identified objects. A normal prediction network 310 and offset unmolding 311 generate offset information for each object. This information is output as respective sets of planes, representing the objects in the scene.

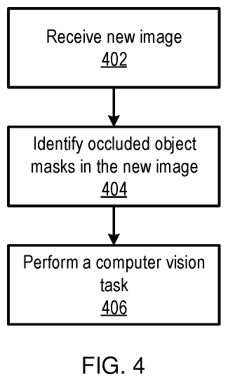

Referring now to FIG. 4, a method of detecting and applying occluded object information is shown. Block 402 receives a new image. For example, this image may be received from a user's camera, such as on a mobile device, an automobile, or on a robotic device, and may depict a scene with multiple objects in it, including one or more occluded objects.

Block 404 identifies the one or more occluded objects within the image. Using the layout branch 320 and the object branch 340 of the network described above, e.g., in FIG. 3, full masks and visible masks can be determined, even for objects that are partially occluded by other objects in the image. This information can be merged using, e.g., semantic merging, as described above. This information may be represented as one or more planes, including the orientation of the plane within the scene and the physical extend of the plane. Depth information may also be determined.

Block 406 then uses the occluded object information to perform a computer vision task. For example, the task may include planning a path for an automobile or robotic device, taking into account the full scale of an object that is only partially visible. The task may also include identifying the partially occluded object to provide information, for example in an alternate-reality display that provides an overlay of information depending on the scene. By enforcing consistency with neighboring views, the trained machine learning model improves the precision of the complete mask that is output for both visible and hidden regions.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

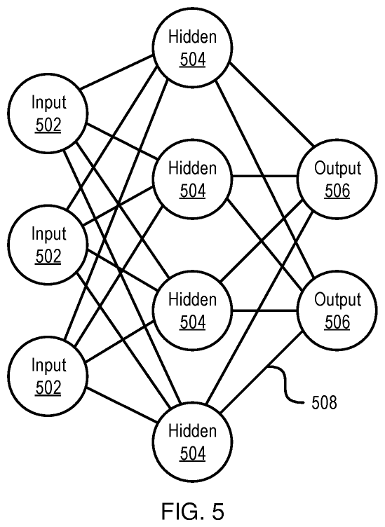

Referring now to FIG. 5, a generalized diagram of a high-level artificial neural network (ANN) is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons 502 that provide information to one or more “hidden” neurons 504. Connections 508 between the input neurons 502 and hidden neurons 504 are weighted and these weighted inputs are then processed by the hidden neurons 504 according to some function in the hidden neurons 504, with weighted connections 508 between the layers. There may be any number of layers of hidden neurons 504, and as well as neurons that perform different functions. There exist different neural network structures as well, such as convolutional neural network, maxout network, etc. Finally, a set of output neurons 506 accepts and processes weighted input from the last set of hidden neurons 504.

This represents a “feed-forward” computation, where information propagates from input neurons 502 to the output neurons 506. Upon completion of a feed-forward computation, the output is compared to a desired output available from training data. The error relative to the training data is then processed in “feed-back” computation, where the hidden neurons 504 and input neurons 502 receive information regarding the error propagating backward from the output neurons 506. Once the backward error propagation has been completed, weight updates are performed, with the weighted connections 508 being updated to account for the received error. This represents just one variety of ANN.

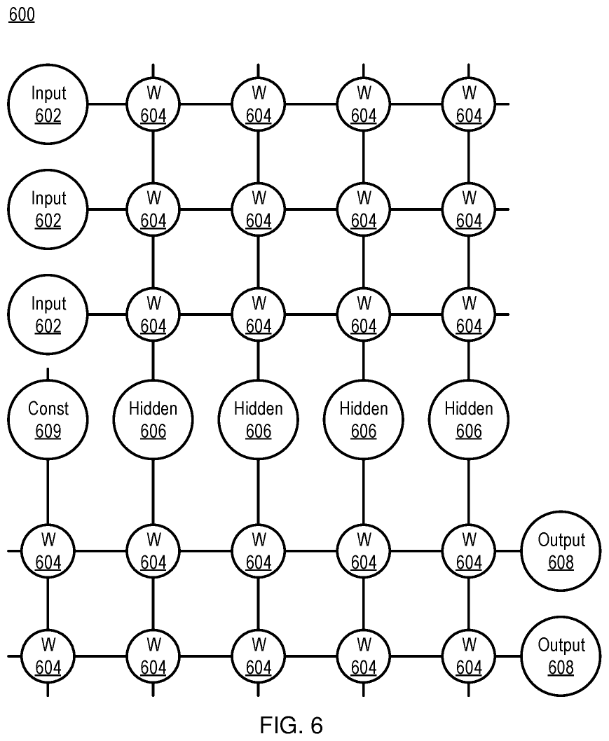

Referring now to FIG. 6, an ANN architecture 600 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 602 each provide an input signal in parallel to a respective row of weights 604. The weights 604 each have a respective settable value, such that a weight output passes from the weight 604 to a respective hidden neuron 606 to represent the weighted input to the hidden neuron 606. In software embodiments, the weights 604 may simply be represented as coefficient values that are multiplied against the relevant signals. The signals from each weight adds column-wise and flows to a hidden neuron 606.

The hidden neurons 606 use the signals from the array of weights 604 to perform some calculation. The hidden neurons 606 then output a signal of their own to another array of weights 604. This array performs in the same way, with a column of weights 604 receiving a signal from their respective hidden neuron 606 to produce a weighted signal output that adds row-wise and is provided to the output neuron 608.

It should be understood that any number of these stages may be implemented, by interposing additional layers of arrays and hidden neurons 606. It should also be noted that some neurons may be constant neurons 609, which provide a constant output to the array. The constant neurons 609 can be present among the input neurons 602 and/or hidden neurons 606 and are only used during feed-forward operation.

During back propagation, the output neurons 608 provide a signal back across the array of weights 604. The output layer compares the generated network response to training data and computes an error. The error signal can be made proportional to the error value. In this example, a row of weights 604 receives a signal from a respective output neuron 608 in parallel and produces an output which adds column-wise to provide an input to hidden neurons 606. The hidden neurons 606 combine the weighted feedback signal with a derivative of its feed-forward calculation and stores an error value before outputting a feedback signal to its respective column of weights 604. This back propagation travels through the entire network 600 until all hidden neurons 606 and the input neurons 602 have stored an error value.

During weight updates, the stored error values are used to update the settable values of the weights 604. In this manner the weights 604 can be trained to adapt the neural network 600 to errors in its processing. It should be noted that the three modes of operation, feed forward, back propagation, and weight update, do not overlap with one another.

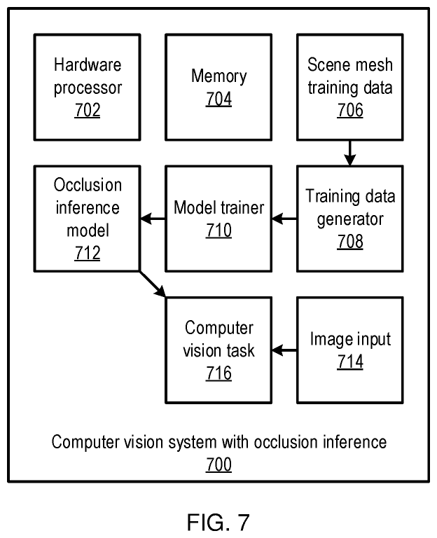

Referring now to FIG. 7, a computer vision system 700 with occlusion inference is shown. The system 700 includes a hardware processor 702 and memory 704. The memory may store scene mesh training data 706 that includes information that characterizes a three-dimensional scene, providing the ability to generate arbitrary views of the scene. A training data generator 708 uses the scene mesh training data to generate masks that include portions of objects that are visible from a given view, and masks that capture the full extent of the object, regardless of occlusion in the given view.

A model trainer 710 uses the generated training data to train occlusion inference model 712. Training may include warping of detected planes in a scene from one view to another to enforce consistency. Once trained, the occlusion inference model 712 takes input images and generates masks that represent the visible portion of objects within the image, as well as inferred information regarding occluded portions of the objects within the image.

A new image input 714 may be generated by any appropriate means, for example including a digital camera, a scanner, or a wholly computer-generated image. A computer vision task 716 uses the image input 714 to make some determination about the visible world, and to take some action based on that determination. To this end, the computer vision task uses the image input 714 as input to the occlusion inference model 712 to generate information regarding object occlusion. This may include, for example, determining the size of an occluded object to aid in pathfinding for a robot or self-driving automobile.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for occlusion detection, comprising:
detecting a set of foreground object masks in an image, including a mask of a visible portion of a foreground object and a mask of the foreground object that includes at least one occluded portion, using a machine learning model;
detecting a set of background object masks in the image, including a mask of a visible portion of a background object and a mask of the background object that includes at least one occluded portion, using the machine learning model;
merging the set of foreground object masks and the set of background object masks using semantic merging; and
performing a computer vision task that accounts for the at least one occluded portion of at least one object of the merged set.

2. The method of claim 1, wherein semantic merging includes non-maxima suppression over the respective sets of the masks that include at least one occluded portion.

3. The method of claim 2, wherein semantic merging further includes determining an overlap between a visible mask of the set of foreground object masks and a visible mask of the set of background object masks.

4. The method of claim 3, wherein semantic merging further includes discarding an overlapping mask having a lower confidence score.

5. The method of claim 1, wherein semantic merging includes calculating an intersection-over-union overlap between a ground truth plane and a predicted plane that has been projected to another view.

6. The method of claim 1, further comprising training the machine learning model using an objective function that enforces consistency between multiple views of a given scene, including occluded regions.

7. The method of claim 6, wherein training the machine learning model comprises warping object masks of a first view into a second view and comparing the warped object masks with ground truth object masks of the second view.

8. The method of claim 6, wherein training the machine learning model comprises separately training a layout part of the machine learning model and an object part of the machine learning model using each view of a training dataset.

9. The method of claim 8, wherein each view of the training dataset is generated by an input mesh, with views from a given input mesh being generated from respective camera viewpoints.

10. The method of claim 9, wherein each foreground object mask and each background object mask includes a normal direction and an offset value.

11. A system for occlusion detection, comprising:
a hardware processor; and
a memory that stores computer program code which, when executed by the hardware processor, implements:
an occlusion inference model that detects a set of foreground object masks in an image, including a mask of a visible portion of a foreground object and a mask of the foreground object that includes at least one occluded portion, that detects a set of background object masks in the image, including a mask of a visible portion of a background object and a mask of the background object that includes at least one occluded portion, and that merges the set of foreground object masks and the set of background object masks using semantic merging; and
a computer vision that takes into account the at least one occluded portion of at least one object of the merged set.

12. The system of claim 11, wherein the occlusion inference model performs non-maxima suppression over the respective sets of the masks that include at least one occluded portion for semantic merging.

13. The system of claim 12, wherein the occlusion inference model determines an overlap between a visible mask of the set of foreground object masks and a visible mask of the set of background object masks for semantic merging.

14. The system of claim 13, wherein the occlusion inference model discards an overlapping mask having a lower confidence score.

15. The system of claim 11, wherein the occlusion inference model calculates an intersection-over-union overlap between a ground truth plane and a predicted plane that has been projected to another view for semantic merging.

16. The system of claim 11, wherein the computer program code further implements a model trainer that trains the occlusion inference model using an objective function that enforces consistency between multiple views of a given scene, including occluded regions.

17. The system of claim 16, wherein the model trainer further warps object masks of a first view into a second view and compares the warped object masks with ground truth object masks of the second view.

18. The system of claim 16, wherein the model trainer further trains a layout part of the occlusion detection model and an object part of the occlusion detection model separately using each view of a training dataset.

19. The system of claim 18, wherein each view of the training dataset is generated by an input mesh, with views from a given input mesh being generated from respective camera viewpoints.

20. The system of claim 19, wherein each foreground object mask and each background object mask includes a normal direction and an offset value.
